(19) United States
(12) Patent Application Publication
(10) Pub. No.: US 2026/0340959 A1
(43) Pub. Date: Oct. 29, 2026

(54) DEPTH DENSIFICATION AND HOLE FILLING WITH DEPTH EDGE PRESERVING FILTERING FOR VIDEO SEE-THROUGH MIXED REALITY OR OTHER APPLICATIONS

(71) Applicant: Samsung Electronics Co., Ltd., Suwon-si (KR)

(72) Inventor: Yingen Xiong, Mountain View, CA (US)

(21) Appl. No.: 19/575,575

(22) Filed: Mar. 23, 2026

Related U.S. Application Data
(60) Provisional application No. 63/796,986, filed on Apr. 29, 2025.

(51) Int. Cl. G06T 19/00; G06T 5/20; G06T 5/70; G06T 7/579; G06T 7/593

(52) U.S. Cl. CPC G06T 19/006; G06T 5/20; G06T 5/70; G06T 7/579; G06T 7/593; G06T 2207/20182; G06T 2207/20192

(57) ABSTRACT

A method includes obtaining, using at least one processing device of an electronic device, input data. The input data includes an image frame sequence of see-through color image frames captured using one or more image sensors and depth data captured using a depth sensor. The method includes performing depth fusion and interpolation on a frame of the image frame sequence using the depth data. The method includes creating a depth edge preserving filter based on structures and features of the image frame, including computing parameters of the depth edge preserving filter, and. performing depth densification and depth hole filling, using the depth edge preserving filter and the parameters, to create a dense depth map of the image frame. The method includes performing passthrough transformation according to the dense depth map and the image frame sequence and processing final view frames for display.

### CROSS-REFERENCE TO RELATED APPLICATION AND PRIORITY CLAIM

This application claims priority under 35 U.S.C. § 119 (e) to U.S. Provisional Patent Application No. 63/796,986 filed on Apr. 29, 2025, which is hereby incorporated by reference in its entirety.

### TECHNICAL FIELD

This disclosure relates generally to imaging systems and processes. More specifically, this disclosure relates to depth densification and hole filling with depth edge preserving filtering for video see-through mixed reality (MR) or other applications.

### BACKGROUND

Extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some MR systems can often seamlessly blend virtual objects generated by computer graphics with real-world scenes.

It is important that XR systems are able to produce final view frames that are accurate and acceptable to the user. Current systems, particularly head-mounted-device systems, cannot accurately sense and reproduce depth information for objects in the three-dimensional scene, which results in inaccurate and disconcerting final view frames being presented to the user.

### SUMMARY

This disclosure relates to depth densification and hole filling with depth edge preserving filtering for video see-through mixed reality (MR) or other applications.

In a first embodiment, a method includes obtaining, using at least one processing device of an electronic device, input data. The input data includes an image frame sequence of see-through color image frames captured using one or more image sensors and depth data captured using a depth sensor. The method includes performing depth fusion and interpolation on a frame of the image frame sequence using the at least one processing device and the depth data. The method includes creating a depth edge preserving filter, using the at least one processing device, based on structures and features of the image frame, including computing parameters of the depth edge preserving filter. The method includes performing depth densification and depth hole filling, using the at least one processing device, the depth edge preserving filter, and the parameters, to create a dense depth map of the image frame. The method includes performing passthrough transformation, using the at least one processing device, according to the dense depth map and the image frame sequence to produce final view frames. The method includes processing, using the at least one processing device, the final view frames for display on at least one display device.

In a second embodiment, an electronic device includes at least one processing device configured to obtain input data. The input data includes an image frame sequence of see-through color image frames captured using one or more image sensors and depth data captured using a depth sensor. The processing device is configured to perform depth fusion and interpolation on a frame of the image frame sequence using the depth data. The processing device is configured to create a depth edge preserving filter based on structures and features of the image frame, including computing parameters of the depth edge preserving filter. The processing device is configured to perform depth densification and depth hole filling, using the depth edge preserving filter and the parameters, to create a dense depth map of the image frame. The processing device is configured to perform passthrough transformation according to the dense depth map and the image frame sequence to produce final view frames. The processing device is configured to process the final view frames for display on at least one display device.

In a third embodiment, a non-transitory machine readable medium contains instructions that when executed cause at least one processor of an electronic device to obtain input data. The input data includes an image frame sequence of see-through color image frames captured using one or more image sensors and depth data captured using a depth sensor. The instructions cause the processor to perform depth fusion and interpolation on a frame of the image frame sequence using the depth data. The instructions cause the processor to create a depth edge preserving filter based on structures and features of the image frame, including computing parameters of the depth edge preserving filter. The instructions cause the processor to perform depth densification and depth hole filling, using the depth edge preserving filter and the parameters, to create a dense depth map of the image frame. The instructions cause the processor to perform passthrough transformation according to the dense depth map and the image frame sequence to produce final view frames. The instructions cause the processor to process the final view frames for display on at least one display device.

Any single one or any combination of the following features may be used with the disclosed embodiments. In some embodiments, the depth data includes depth information reconstructed from stereo image pairs of the image frame sequence, and performing depth densification and depth hole filling includes fusing depth information reconstructed from the stereo image pairs with the depth data captured using the depth sensor, interpolating depths for depth-empty pixels of the image frame based on depth densification and depth hole filling, creating a confidence map with confidence scores for individual pixels of the image frame, and creating an initial estimation of the dense depth map based on the confidence map, the depth data, and the interpolated depths.

In some embodiments, creating a depth edge preserving filter includes creating a relationship between the depth data and the structures and features of the image frame, and integrating the parameters with the depth edge preserving filter. The parameters of the depth edge preserving filter are based on the relationship.

In some embodiments, performing depth densification and depth hole filling includes finalizing depths at individual pixels of the image frame having low confidence scores of estimated depths, using the depth edge preserving filter, and removing noise at the individual pixels of the image frame having low confidence scores of estimated depths using the depth edge preserving filter.

In some embodiments, performing depth densification and depth hole filling includes performing post processing for the dense depth map based on the finalized depths.

In some embodiments, the image frame sequence includes stereo image pairs of color image frames captured using multiple image sensors and the depth data includes depth information reconstructed from the stereo image pairs. In some embodiments, the depth data includes structure from motion information computed from the image frame sequence.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device according to this disclosure;

FIG. 2 illustrates an example high-level process for depth densification and hole filling with depth edge preserving filtering for video see-through mixed reality or other applications in accordance with this disclosure;

FIG. 3 illustrates a more detailed process for depth densification and hole filling with depth edge preserving filtering for video see-through MR in accordance with this disclosure;

FIG. 4 illustrates a process for initial estimation of depth maps with depth fusion and depth interpolation in accordance with this disclosure;

FIG. 5 illustrates a non-limiting example of fusing depths in accordance with this disclosure;

FIG. 6 illustrates a process for creating depth edge preserving filtering for depth computing in accordance with this disclosure;

FIG. 7 illustrates an example of creating a depth edge preserving filter with parameters in accordance with this disclosure;

FIG. 8 illustrates a non-limiting example of integration of the depth edge preserving filter in accordance with this disclosure;

FIG. 9 illustrates a process for depth densification and depth hole filtering with edge preserving filtering in accordance with this disclosure;

FIG. 10 illustrates a non-limiting example of finalizing depths with the depth edge preserving filter in accordance with the disclosure;

FIG. 11A illustrates a non-limiting example of depth filtering in accordance with this disclosure;

FIG. 11B illustrates a non-limiting example of overlapping windows in depth filtering in accordance with this disclosure; and

FIG. 12 illustrates an integrated process for depth densification and hole filling with depth edge preserving filtering for video see-through mixed reality or other applications in accordance with this disclosure.

### DETAILED DESCRIPTION

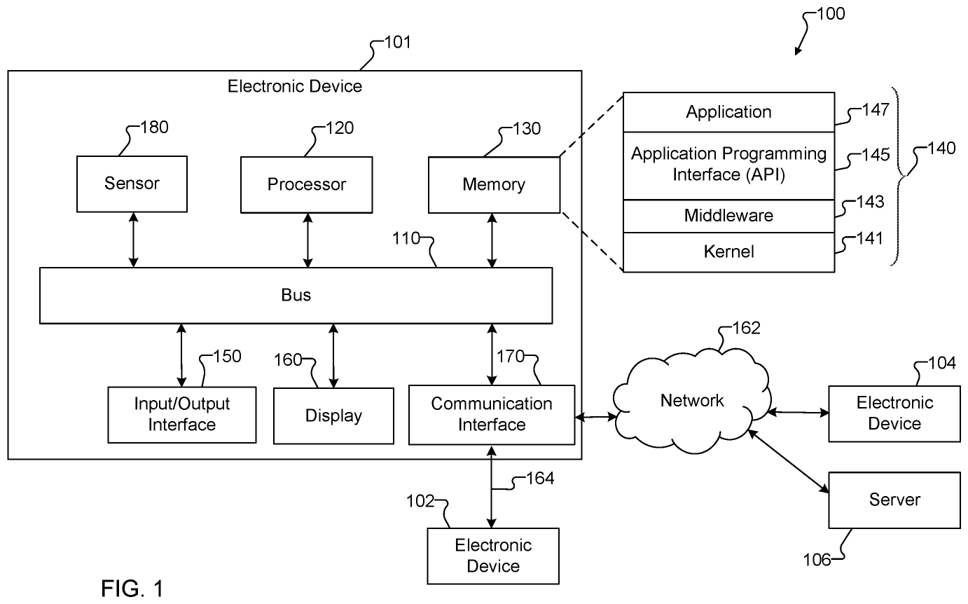

FIGS. 1 through 12, discussed below, and the various embodiments of this disclosure are described with reference to the accompanying drawings. However, it should be appreciated that this disclosure is not limited to these embodiments and all changes and/or equivalents or replacements thereto also belong to the scope of this disclosure.

As noted above, extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

Optical see-through (OST) XR systems refer to XR systems (including OST ME systems) in which users directly view real-world scenes through head-mounted devices (HMDs). Unfortunately, OST XR systems face many challenges that can limit their adoption. Some of these challenges include limited fields of view, limited usage spaces (such as indoor-only usage), failure to display fully-opaque black objects, and usage of complicated optical pipelines that may require projectors, waveguides, and other optical elements. In contrast to OST XR systems, video see-through (VST) XR systems (also called “passthrough” XR systems) present users with generated video sequences of real-world scenes. VST XR systems can be built using virtual reality (VR) technologies and can have various advantages over OST XR systems. For example, VST XR systems can provide wider fields of view and can provide improved contextual augmented reality.

A VST XR device often includes one or more imaging sensors (also called “see-through cameras”) that capture high-resolution image frames of a user's surrounding environment. These image frames are processed in an image processing pipeline in order to generate final rendered views of the user's surrounding environment. Visual quality of final view frames directly affects a user's experiences with the VST XR device. The visual quality of the final view frames often depends on the visual quality of the captured image frames.

VST MR systems obtain high-resolution color frames, combine the captured frame images with virtual objects generated by graphics, and render the images to the display panels after passthrough transformations. The user can see the enhanced images on the display panels through display lenses.

Video see-through AR captures scene videos with high-resolution see-through color cameras and combines the high-resolution color videos with virtual objects generated by computer graphics. The combined video is rendered, for example, to the display panels on head-mounted display (HMD) headset devices. The user sees the final images of enhanced screen.

Depth maps of the captured scene are important in generating the final view images with passthrough transformations. Depth-based viewpoint matching and parallax correction, depth-based reprojection are used in creating final views in the video see-through mixed reality (MR) pipeline.

An HMD can obtain depths for different depth sources, such as depths from depth sensors, depths from stereo image pairs, depths from SFM. However, typical approaches result in low-resolution and sparse depths from these depth sources. Passthrough transformations need dense depth maps, so this data is typically insufficient. The resolution of the dense depth maps is the same as the captured high-resolution see-through color frames.

To generate high quality final view images and display on the display panels, high-resolution dense depth maps can be used to transform the captured high-resolution color frames from the see-through camera viewpoint to the user's eye viewpoint and compensate user's head pose changes while generating the final views. The transformations include depth-based viewpoint matching and parallax correction, depth-based reprojection for head pose change compensation.

To obtain high-resolution dense depth maps from captured low-resolution sparse depths, disclosed embodiments include processes and techniques for depth densification and hole filling with edge preserving filtering. Disclosed embodiments can fuse depths captured from different depth sources, densify the sparse depths to create a dense depth map, and fill depth holes by computing new depths with the created depth edge preserving filter. Systems and devices as disclosed herein can create a high-resolution dense depth map from captured low-resolution sparse depths for passthrough transformations to generate high-quality final view images for video see-through MR.

This disclosure provides various techniques related to depth densification and hole filling with depth edge preserving filtering for video see-through MR or other applications. As described in more detail below, disclosed embodiments include processes for depth mapping and correction for video see-through mixed reality or other applications.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to depth densification and hole filling with depth edge preserving filtering for video see-through mixed reality (MR) or other applications.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform depth densification and hole filling with depth edge preserving filtering for video see-through mixed reality (MR) or other applications. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include one or more cameras or other imaging sensors, which may be used to capture images of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit (IMU) that can include one or more accelerometers, gyroscopes, and other components, which can capture, for example, motion information and head pose information. The sensor(s) 180 can also include one or more eye tracking sensors that track a user's eye position, movement, and/or focus, which can be implemented using imaging sensors. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to depth densification and hole filling with depth edge preserving filtering for video see-through mixed reality (MR) or other applications.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

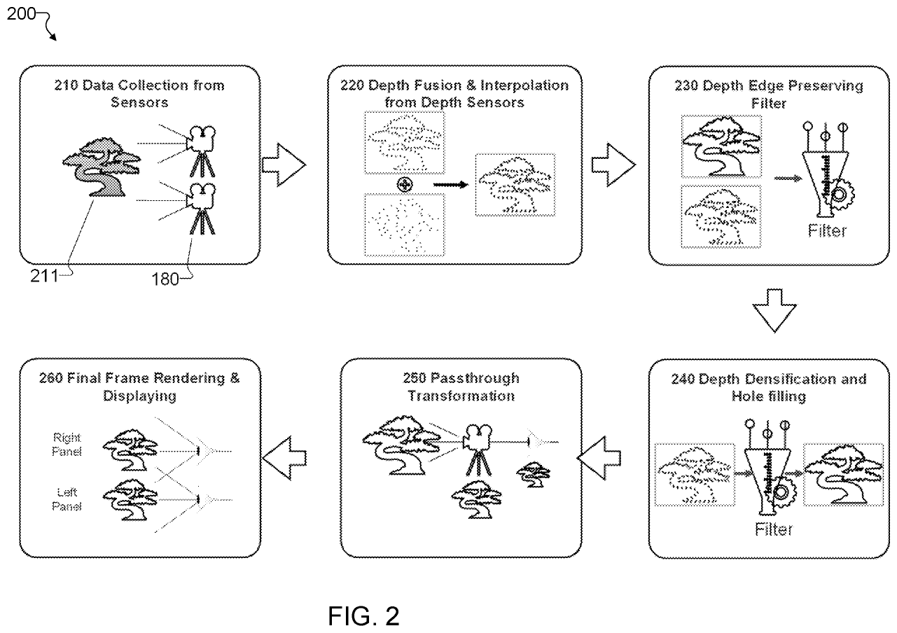

FIG. 2 illustrates an example high-level process 200 for depth densification and hole filling with depth edge preserving filtering for video see-through MR or other applications in accordance with this disclosure. For ease of explanation, the process 200 of FIG. 2 is described as being implemented using the electronic device 101 in the network configuration 100 of FIG. 1. However, the process 200 may be implemented using any other suitable device(s) (such as the server 106) and in any other suitable system(s). The high-level processes described in the context of FIG. 2 can include any number of other processes and subprocesses, including those described with respect to other figures herein.

The high-level process illustrated in FIG. 2 allows the electronic device, among other things to create and process depth maps for generating final view frames using an edge-preserving filter for video see-through MR.

The electronic device can obtain input data at step 210. This can include, for example, collecting input data of the video see-through pipeline by capturing see-through color frames of a scene 211 with, for example, see-through camera sensors, capturing depth data with depth sensors, capturing stereo image pairs with tracking cameras (which can be the same see-through camera sensors), and head pose data with positional sensors. Any of these sensors can be implemented as sensors 180 as described above.

The electronic device can create dense depth maps from sparse depths for depth-based processing in the video see-through MR pipeline including performing depth fusion and interpolation at step 220, using depths from different depth sources such as depths from depth sensors, depths from “structure from motion,” and depths from stereo image pairs.

The electronic device can create a depth edge preserving filter for computing new depths with guidance of corresponding color images and computing parameters of the filter at step 230.

The electronic device can perform depth densification and depth hole filling at step 240, which can include generating new depths with the created depth edge preserving filter to create dense depth maps for depth-based processing.

The electronic device can generate the final view frames with passthrough transformations including static transformation and depth-based dynamic transformation from the captured see-through frames at step 250.

Finally, the electronic device can render the see-through frame to the display panels for video see-through MR 260.

Although FIG. 2 illustrates one example of a high-level process 200 for depth densification and hole filling with depth edge preserving filtering for video see-through MR or other applications, various changes may be made to FIG. 2. For example, various operations or functions in FIG. 2 may be combined, further subdivided, replicated, omitted, or rearranged and additional operations or functions may be added according to particular needs. Also, different portions of the process 200 could be performed using different devices, such as when one or more operations are performed by a first electronic device (like an HMD) and one or more other operations is performed offline by a second electronic device, for example to determine or configure appropriate parameters, or before the first electronic device is deployed.

The process illustrated in FIG. 2 provides significant technical advantages when implemented in a head-mounted display (HMD). By integrating depth fusion, edge preserving filtering, and depth densification directly within the HMD's processing pipeline, the disclosed approach enables real-time generation of high-quality dense depth maps without relying on external computational resources. This on-device processing reduces latency between scene capture and final view rendering, which is critical for maintaining visual comfort and reducing motion sickness in video see-through applications. Additionally, the structured pipeline architecture allows for efficient utilization of the HMD's computational resources, enabling the generation of visually coherent passthrough views that accurately reflect the user's physical environment.

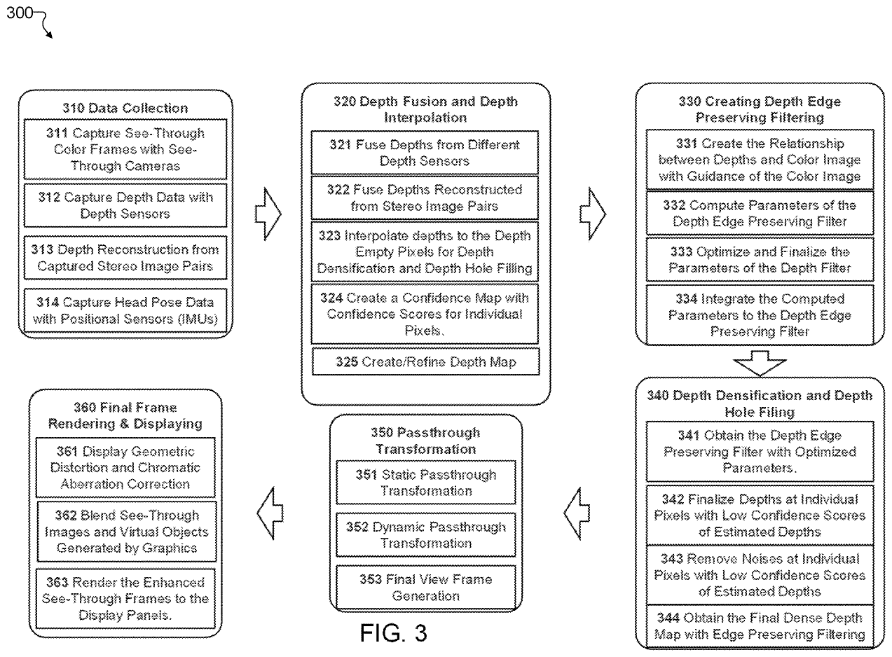

FIG. 3 illustrates a more detailed process 300 for depth densification and hole filling with depth edge preserving filtering for video see-through MR in accordance with this disclosure. For ease of explanation, the process 300 of FIG. 3 is described as being implemented using the electronic device 101 in the network configuration 100 of FIG. 1. However, the process 300 may be implemented using any other suitable device(s) (such as the server 106) and in any other suitable system(s). The high-level processes described in the context of FIG. 3 can include any number of other processes and subprocesses, including those described with respect to other figures herein.

FIG. 3 includes a number of high-level actions that can be performed the electronic device, each of which can include one or more sub-steps. In this example, process 300 includes high-level actions of data collection at step 310, depth fusion and depth interpolation at step 320, creating depth edge preserving filtering at step 330, depth densification and depth hole filling at step 340, passthrough transformation at step 350, and final frame rendering and displaying at step 360.

As part of the process of data collection at step 310, the electronic device can capture see-through color frames with see-through cameras 311. The see-through cameras can include high-resolution image sensors capable of capturing color image frames at frame rates suitable for real-time video see-through applications. In some implementations, the see-through cameras can capture stereo image pairs that enable depth reconstruction through disparity analysis.

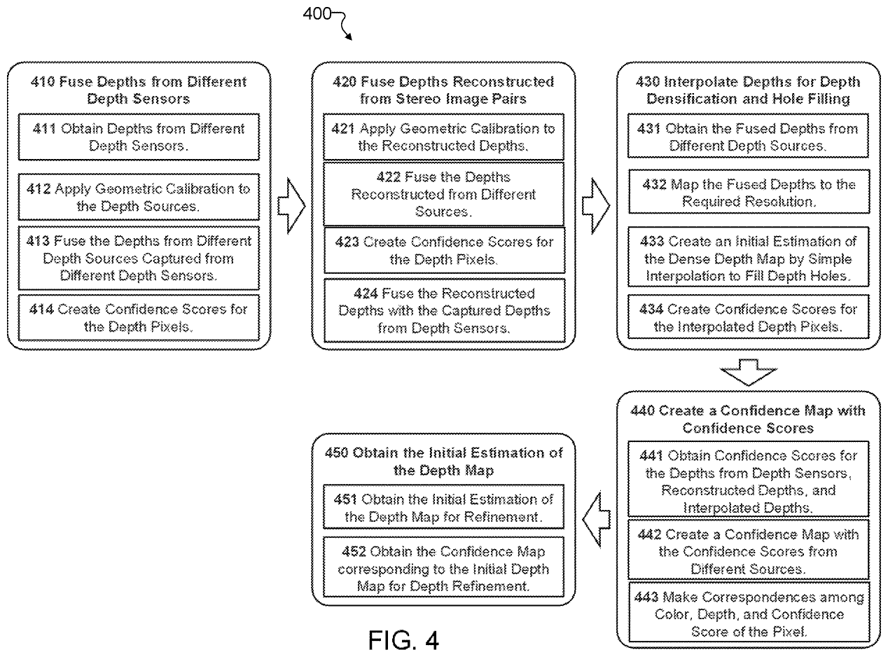

As part of the process of data collection at step 310, the electronic device can capture depth data with depth sensors 312. The depth sensors can include time-of-flight (ToF) sensors, LIDAR sensors, or structured light sensors that capture depth information for objects in the scene. As described with respect to process 400 in FIG. 4, the electronic device can assign high confidence scores to depths captured directly from depth sensors.

As part of the process of data collection at step 310, the electronic device can reconstruct depths from captured stereo image pairs at step 313. Depth reconstruction from stereo image pairs can include computing disparity maps by matching corresponding features between left and right images, and converting the disparity values to depth values based on the baseline distance between cameras and focal length parameters. The reconstructed depths can be fused with depths from depth sensors as described in process 400 of FIG. 4.

As part of the process of data collection at step 310, the electronic device can capture head pose data with positional sensors at step 314, such as by using inertial motion units (IMUs).

As part of the process of depth fusion and depth interpolation at step 320, the electronic device can fuse depths from different depth sensors at step 321. This can include fusing data from depth sensors such as time-of-flight (ToF) sensors or LIDAR sensors.

As part of the process of depth fusion and depth interpolation at step 320, the electronic device can fuse reconstructed or inferred depths at step 322, such as depths reconstructed from stereo image pairs in the input data or depths from a surface from motion (SFM) analysis.

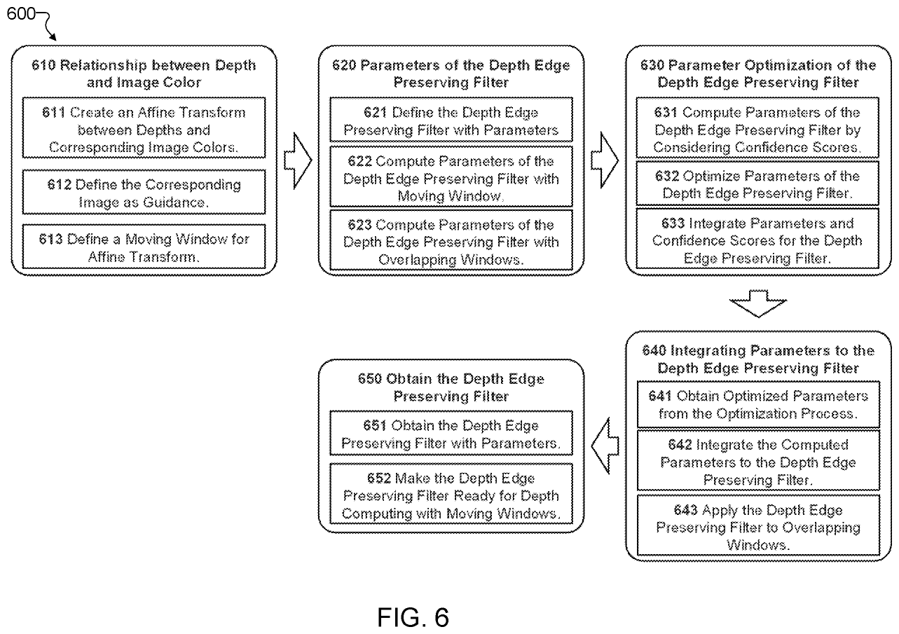

As part of the process of depth fusion and depth interpolation at step 320, the electronic device can interpolate depths to the depth empty pixels for depth densification and depth hole filling at step 323. Depth interpolation can include applying interpolation techniques such as bilinear interpolation or nearest neighbor interpolation to estimate depth values for pixels that lack direct depth measurements. In some cases, the interpolated depths provide initial estimates that can be refined using the depth edge preserving filter described in process 600 of FIG. 6.

As part of the process of depth fusion and depth interpolation at step 320, the electronic device can create a confidence map with confidence scores for individual pixels at step 324. The confidence map can assign scores based on the source and reliability of each pixel's depth value, with depths from depth sensors receiving higher confidence scores than interpolated or reconstructed depths. As described in process 400 of FIG. 4, the confidence scores can guide subsequent depth refinement operations by identifying pixels that require additional processing.

As part of the process of depth fusion and depth interpolation at step 320, the electronic device can create a depth map of the captured scene at step 325, for example based on the depths determined at steps 321-323 and the confidence map created at step 324. This can include creating an estimated initial depth map for the captured scene, and can include refining the initial depth map to create a dense depth map of the captured scene.

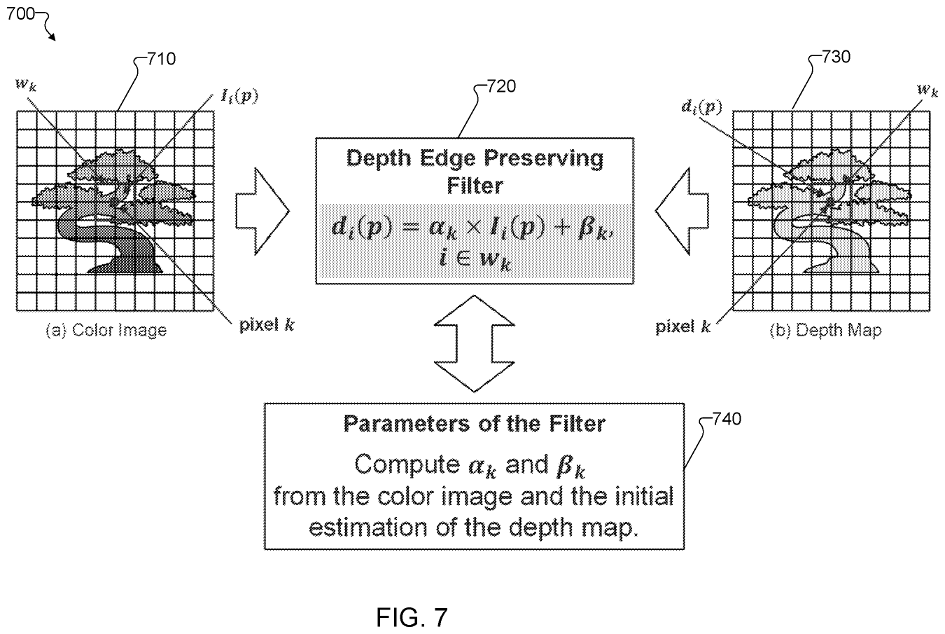

As part of the process of creating depth edge preserving filtering at step 330, the electronic device can create the relationship between depths and color image with guidance of the color image at step 331. Creating this relationship can include establishing an affine transform between depth values and corresponding pixel colors within local image patches, as illustrated in FIG. 7. The relationship enables the filter to leverage color image structure to guide depth refinement while preserving edges at object boundaries.

As part of the process of creating depth edge preserving filtering at step 330, the electronic device can compute parameters of the depth edge preserving filter with the color image and the initial depth map at step 332. Computing the filter parameters can include determining linear coefficients that relate depth values to color values within moving windows across the image, as described in process 600 of FIG. 6. The computed parameters can enable the filter to propagate depth information while respecting color-based edge boundaries.

As part of the process of creating depth edge preserving filtering at step 330, the electronic device can optimize and finalize the parameters of the depth edge preserving filter with the guided color image at step 333. Parameter optimization can include considering confidence scores of the initial depth estimates and adjusting the filter parameters to weight more reliable depth sources more heavily. The optimization process can ensure that the finalized parameters produce accurate depth estimates while minimizing artifacts at depth discontinuities.

As part of the process of creating depth edge preserving filtering at step 330, the electronic device can integrate the computed parameters to the depth edge preserving filter for depth densification and depth hole filling from the initial depth map with guidance of the color image at step 334.

As part of the process of depth densification and depth hole filling at step 340, the electronic device can obtain the created depth edge preserving filter with optimized parameters at step 341. The depth edge preserving filter with optimized parameters can be created through process 600 of FIG. 6, which establishes the relationship between depth and color, computes filter parameters using moving windows, and integrates the optimized parameters into the filter structure.

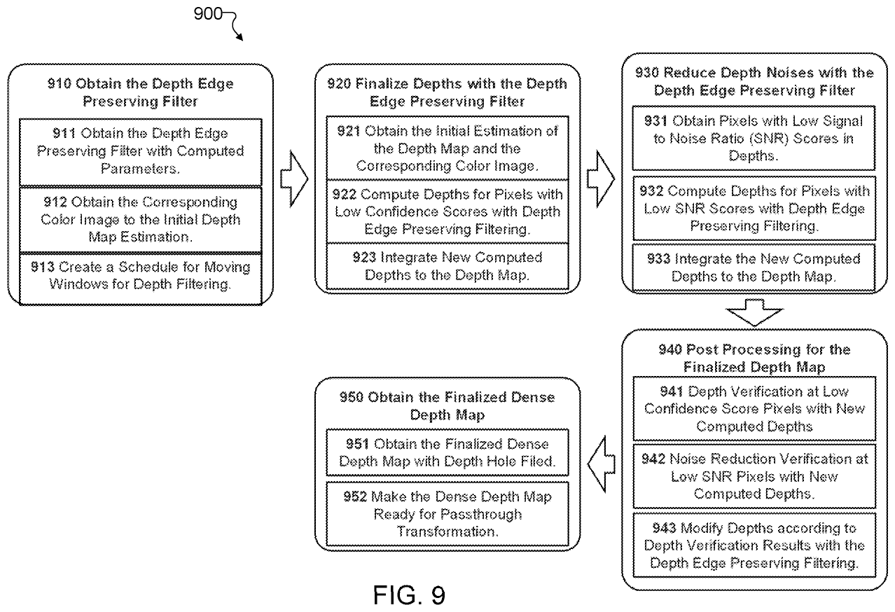

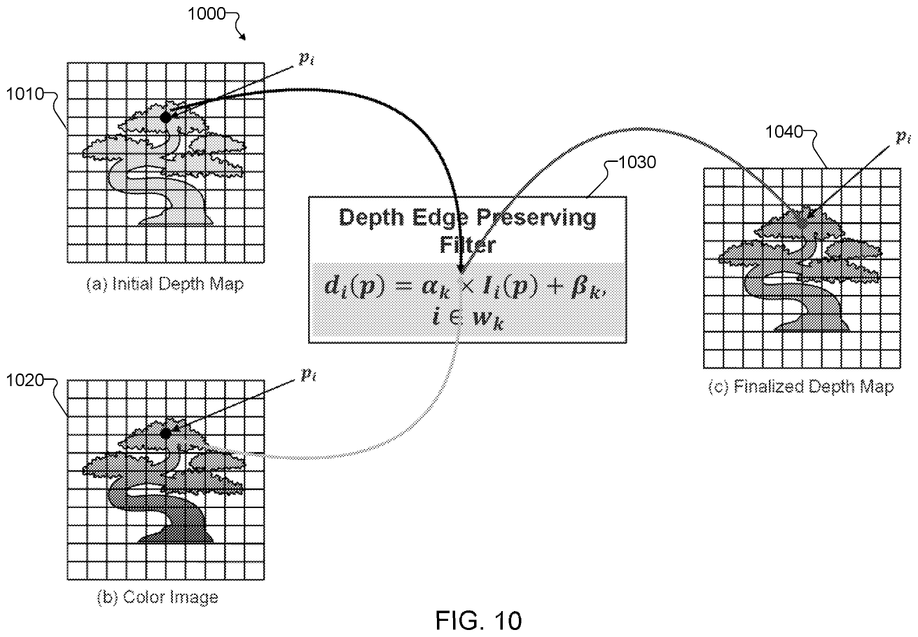

As part of the process of depth densification and depth hole filling at step 340, the electronic device can finalize the depths at individual pixels which have low confidence scores of the initial estimated depths at step 342. Finalizing depths at low-confidence pixels can include applying the depth edge preserving filter to compute new depth values based on neighboring pixels with higher confidence scores and guided by the corresponding color image structure. This process is further detailed, for example, in step 920 of process 900 in FIG. 9 and illustrated in FIG. 10.

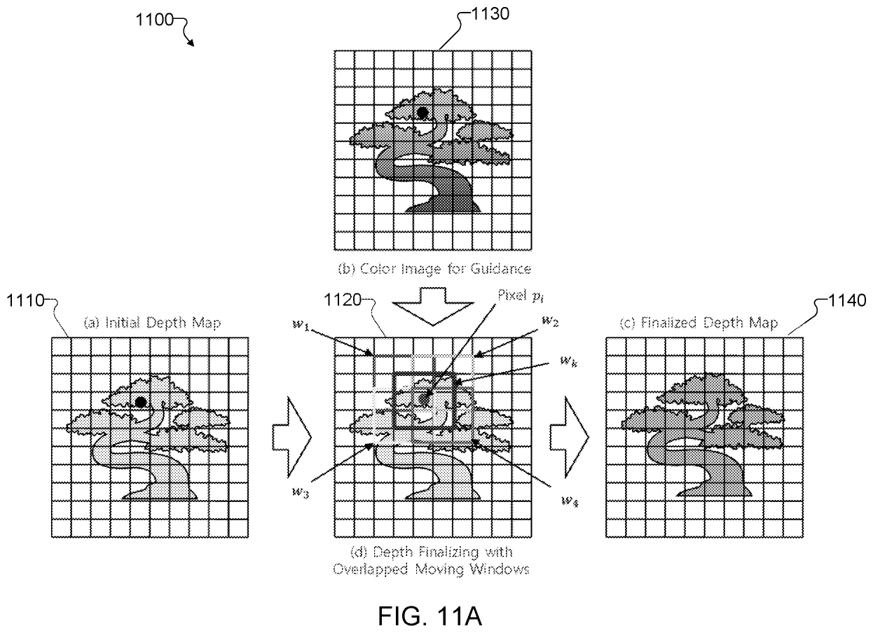

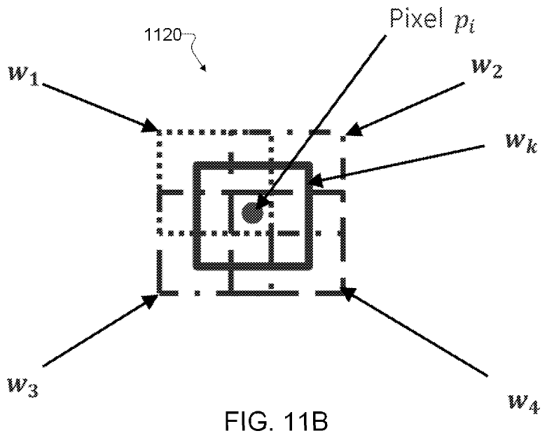

As part of the process of depth densification and depth hole filling at step 340, the electronic device can remove noise at individual pixels which have low confidence scores of the initial estimated depths at step 343. Noise removal can include applying the depth edge preserving filter to smooth depth values while preserving sharp transitions at object edges, thereby reducing artifacts caused by sensor noise or reconstruction errors. This process is further detailed, for example in step 930 of process 900 in FIG. 9 and illustrated in FIG. 11.

As part of the process of depth densification and depth hole filling at step 340, the electronic device can obtain the dense depth map from the initial estimation with created depth edge preserving filtering at step 344. The dense depth map can represent a complete depth representation at the same resolution as the input color image, with depth values assigned to all pixels including those that originally lacked depth measurements. The dense depth map is ready for use in passthrough transformation as described at step 350.

As part of the process of passthrough transformation at step 350, the electronic device can perform a static passthrough transformation at step 351, for example when the captured scene includes minimal movement.

As part of the process of passthrough transformation at step 350, the electronic device can perform a dynamic passthrough transformation at step 352 for example when the captured scene includes significant motion and/or the user's head or eye pose changes significantly.

As part of the process of passthrough transformation at step 350, the electronic device can generate the final view frames at step 353 based on the input data and the dense depth map of the captured scene created by the depth edge preserving filter.

As part of the process of final frame rendering and displaying at step 360, the electronic device can perform display geometric distortion and chromatic aberration correction at step 361. Geometric distortion correction can include, for example, applying inverse lens distortion models to compensate for barrel or pincushion distortion introduced by the display optics. Chromatic aberration correction can include, for example, applying wavelength-dependent corrections to align the red, green, and blue color channels that may be displaced differently by the optical system.

As part of the process of final frame rendering and displaying at step 360, the electronic device can blend see-through images and virtual objects generated by graphics at step 362. Blending can include compositing virtual objects with the see-through images using, for example, alpha blending or depth-based occlusion techniques that ensure virtual objects appear correctly positioned relative to real-world objects. The dense depth map created through the disclosed processes can enable accurate occlusion handling where real-world objects can properly occlude virtual objects based on their relative depths.

As part of the process of final frame rendering and displaying at step 360, the electronic device can render the enhanced see-through frames to the display panels and provide the rendered final views to the user at step at step 363.

The process as illustrated in FIG. 3 includes a number of innovative techniques that provide significant technical advantages over other approaches. For example, the process of depth fusion and depth interpolation illustrated at step 320 can be used for creating initial estimation of the dense depth map from captured sparse depths. The process of creating depth edge preserving filtering at step 330 can be used for creating the depth edge preserving filter with optimized parameters. The process of depth densification and depth hole filling at step 340 can be used for creating a dense depth map for the captured scene with the created depth edge preserving filter from the initial estimated depth map.

Particular other distinctions and advantages over other systems include creating depth fusion with depths from different sources and depth interpolation to generate estimation of the depth map with initial depth densification and depth hole filling. Another advantage is the ability to perform depth edge preserving filtering with guidance of the corresponding color image and to compute parameters of the depth edge preserving filter with the image structure and feature information from the color image frames. Another advantage is the ability to refine the initial estimated depth map with created depth edge preserving filter to generate accurate depths and remove noises created in depth capturing and depth reconstruction.

Although FIG. 3 illustrates one example of more detailed process 300 for depth densification and hole filling with depth edge preserving filtering for video see-through MR or other applications, various changes may be made to FIG. 3. For example, various operations or functions in FIG. 3 may be combined, further subdivided, replicated, omitted, or rearranged and additional operations or functions may be added according to particular needs. Also, different portions of the process 300 could be performed using different devices, such as when one or more operations are performed by a first electronic device (like an HMD) and one or more other operations is performed offline by a second electronic device, for example to determine or configure appropriate parameters, or before the first electronic device is deployed.

The process illustrated in FIG. 3 provides significant technical advantages when implemented in a head-mounted display. The detailed process flow enables efficient coordination between multiple sensor modalities, including see-through cameras, depth sensors, and positional sensors, all integrated within the HMD form factor. By performing depth fusion, edge preserving filter creation, and depth hole filling as a unified pipeline within the HMD, the disclosed approach minimizes data transfer overhead and reduces processing latency. This integrated architecture allows the HMD to generate accurate final view frames that properly compensate for head pose changes and provide seamless blending of virtual objects with real-world scenes, thereby enhancing user immersion and visual fidelity in video see-through mixed reality applications.

FIG. 4 illustrates a process 400 for initial estimation of depth maps with depth fusion and depth interpolation in accordance with this disclosure. For ease of explanation, the process 400 of FIG. 4 is described as being implemented using the electronic device 101 in the network configuration 100 of FIG. 1. However, the process 400 may be implemented using any other suitable device(s) (such as the server 106) and in any other suitable system(s). The high-level processes described in the context of FIG. 4 can include any number of other processes and subprocesses, including those described with respect to other figures herein.

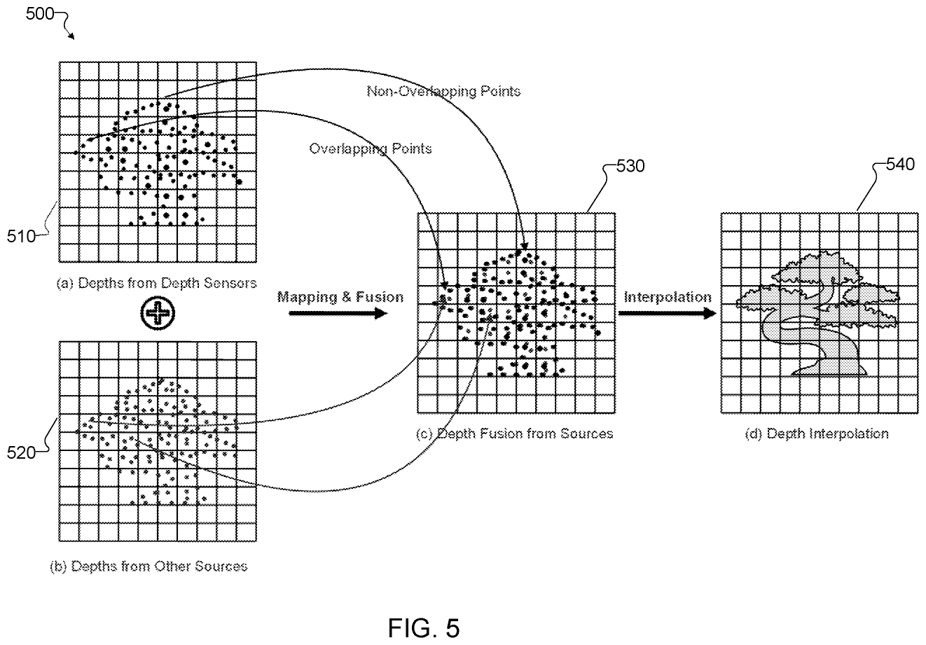

FIG. 4 includes a number of high-level actions that can be performed the electronic device, each of which can include one or more sub-steps. In this example, process 400 includes high-level actions of fusing depths from different depth sensors at step 410, fusing depths reconstructed from stereo image pairs at step 420, interpolating depths for depth densification and hole filling at step 430, creating a confidence map with confidence scores at step 440, and obtaining the initial estimation of the depth map at step 450. Some aspects of the process 400 may be illustrated with respect to FIG. 5, below.

As part of the process of fusing depths from different depth sensors at step 410, the electronic device can obtain depths from different depth sensors at step 411. The different depth sensors can include time-of-flight (ToF) sensors that measure depth based on light travel time, LIDAR sensors that use laser pulses for ranging, and structured light sensors that project patterns onto the scene. Each depth sensor type may have different range capabilities, resolution characteristics, and noise profiles.

As part of the process of fusing depths from different depth sensors at step 410, the electronic device can apply geometric calibration to the depth source to align different depth sensors at step 412.

As part of the process of fusing depths from different depth sensors at step 410, the electronic device can fuse the depths from different depth sources captured from different depth sensors at step 413. Fusing depths from multiple sources can include combining depth measurements at corresponding pixel locations using weighted averaging based on the confidence or reliability of each source. When multiple sensors provide depth measurements for the same scene point, the fused depth can leverage the complementary strengths of different sensor modalities.

As part of the process of fusing depths from different depth sensors at step 410, the electronic device can also create confidence scores for the depth pixels at step 414. The electronic device can trust the depths of depth sensors and assign the highest confidence score 1 to the depth pixels and assign confidence score 0 to the pixels which do not have depth. The electronic device can compute the fusing depth for depth sensor data as

$$\{ \begin{matrix}{d}_{fs} ( p ) = {d}_{s} ( p ) , if there is only one depth at pixel p , \\ {d}_{fs} ( p ) = average ( {d}_{si} ( p ) ) , if there multiple depths at pixel p , \\ {d}_{fs} ( p ) = 0 , if there is no depth at pixel p .\end{matrix}$$

where d_{fs} is the depth captured with depth sensors. The electronic device can create the confidence score for sensor depth data at each pixel p for the fusing depth S_{fs}(p) as

$$\{ \begin{matrix}{S}_{fs} ( p ) = 1 , if there is a depth at pixel p , \\ {S}_{fs} ( p ) = 0. if there is no depth at pixel p .\end{matrix}$$

Based on these equations, the electronic device can compute fused depths and confidence scores from depths captured from depth sensors.

As part of the process of fusing depths reconstructed from stereo image pairs at step 420, the electronic device can apply geometric calibration to the reconstructed depths at step 421. Geometric calibration can include transforming the reconstructed depths from the stereo camera coordinate system to a common reference frame aligned with the depth sensor coordinate system. The calibration parameters can be determined during a calibration procedure that establishes the spatial relationships between the different imaging systems.

As part of the process of fusing depths reconstructed from stereo image pairs at step 420, the electronic device can fuse the depths reconstructed from different sources at step 422. Fusing reconstructed depths can include combining depths obtained from stereo matching with depths computed from structure from motion (SFM) analysis. The fusion process can weight the contributions based on confidence scores that reflect the reliability of each reconstruction method for different scene regions.

As part of the process of fusing depths reconstructed from stereo image pairs at step 420, the electronic device can create confidence scores to the depth pixels at step 423. The electronic device can compute the fusing depth for reconstructed depth data as

$$\{ \begin{matrix}{d}_{fr} ( p ) = {d}_{r} ( p ) , if there is only one reconstructed depth at pixel p , \\ {d}_{fr} ( p ) = average ( {d}_{ri} ( p ) ) , if there are multiple reconstructed depths at pixel p , \\ {d}_{fr} ( p ) = 0 , if there is not any reconstructed depth at pixel p .\end{matrix}$$

where d_{fr} is the depth reconstructed from stereo image pairs.

The electronic device can compute the confidence score S_{fr}(p) for reconstructed depth data at each pixel p at step 423 as

$$\{ \begin{matrix}{S}_{fr} ( p ) = {S}_{r} ( p ) , if there is only one reconstructed depth at pixel p , \\ {S}_{fr} ( p ) = average ( {S}_{ri} ( p ) ) , if there are multiple reconstructed depths at pixel p , \\ {S}_{fr} ( p ) = 0 , if there is not any reconstructed depth at pixel p .\end{matrix}$$

Based on these equations, the electronic device can compute fused depths and confidence scores from reconstructed depths.

As part of the process of fusing depths reconstructed from stereo image pairs at step 420, the electronic device can fuse the reconstructed depths with the captured depths from depth sensors at step 424. This fusion can combine the high-confidence depths from dedicated depth sensors with the denser coverage often provided by stereo reconstruction, such as illustrated in FIG. 5. The combined depth data can provide a more complete representation of scene depth than either source alone.

To illustrates this process, FIG. 5 shows a non-limiting example 500 of fusing the depths d_{fs}(p) captured from depth sensors, shown at 510, with the depths d_{fr}(p) reconstructed from stereo image pairs or structure from motion, as shown at 520, to obtain the fused depths d_{f}(p) shown at 530. In this fusing process, the electronic device can use:

$${d}_{f} ( p ) = \{ \begin{matrix}{d}_{fs} ( p ) , if only sensor depth exists , \\ {d}_{fs} ( p ) = if both sensor depth and reconstructed depth exist , \\ {d}_{fr} ( p ) , if only reconstructed depth exists , \\ 0 , i f no depth exists .\end{matrix}$$

where d_{fs} is the depth captured with depth sensors, d_{fr} is the depth reconstructed from stereo image pairs.

The electronic device can define the range of the confidence scores as [0, 1]. The electronic device can fully trust depths captured from depth sensors d_{fs} and give the highest confidence score 1. The electronic device can set score 0 to the pixel without depth. The electronic device can use the confidence scores obtained from depth reconstruction for the reconstructed depths d_{fr}.

As part of the process of interpolating depths for depth densification and hole filling at step 430, the electronic device can obtain the fused depths from different depth sources d_{f} at step 431. The fused depths can represent the combined depth information from depth sensors and reconstructed depths, along with their associated confidence scores. The fused depth data can serves as the input for subsequent interpolation and densification operations.

As part of the process of interpolating depths for depth densification and hole filling at step 430, the electronic device can map the fused depth to the required resolution at step 432. Mapping to the required resolution can include, for example, upsampling lower-resolution depth data to match the resolution of the high-resolution see-through color images. The resolution mapping can use interpolation techniques that preserve depth discontinuities at object boundaries.

As part of the process of interpolating depths for depth densification and hole filling at step 430, the electronic device can create an initial estimation of the dense depth map by simple interpolation to fill depth holes at step 433. The electronic device can compute the interpolation depths below.

With the depth fusion process, the electronic device can create a set of sparse depths (illustrated at 530) corresponding to the color image. With the fused sparse depths, the electronic device can create an initial estimation of the depth map with simple interpolation at step 433. Depth interpolation is illustrated at 540.

Suppose dᵢ is an interpolation depth for the pixel which does not have depth. As part of the process of interpolating depths for depth densification and hole filling at step 430, the electronic device can compute the depth dᵢ and confidence score Sᵢ for each pixel p at step 434 as

$$\{ \begin{matrix}{d}_{i} ( p ) = f ( {d}_{neighbors} ) \\ {S}_{i} ( p ) = g ( {S}_{neighbors} )\end{matrix}$$

where d_{neighbors} are the depths of neighboring pixels, S_{neighbors} are the confidence scores of neighboring pixels, ƒ(⋅) is an interpolation function, and g(⋅) is the function for computing a confidence score with the scores of neighboring pixels.

For example, the electronic device can use bilinear interpolation, or nearest neighbor interpolation as the interpolation function to compute the interpolation depths. If the pixel does not have depth, it can be assigned 0 as depth and confidence score. The interpolation process estimates a proper depth with the neighboring depths to the pixel.

Using the depth fusion and depth interpolation processes such as step 410, step 420, and step 430, the electronic device can create an initial estimation of the dense depth map which can be further finalized as the dense depth map.

For the depth of each pixel in the initial estimation dense depth map, the electronic device can use

$$d ( p ) = \{ \begin{matrix}{d}_{fs} ( p ) , if there is depth sensor depth exists , \\ {d}_{fr} ( p ) , if there is only reconstructed depth exists , \\ {d}_{i} ( p ) , if there is only interpolated depth exists .\end{matrix}$$

where depths d_{fs}(p) captured from depth sensors, shown at 510, are fused with the depths d_{fr}(p) reconstructed from stereo image pairs or structure from motion, as shown at 520, to obtain the fused depths d_{f}(p) shown at 530.

As part of the process of creating a confidence map with confidence scores at step 440, the electronic device can obtain confidence scores for the depths from depth sensors S_{fs}(p), for reconstructed depths S_{fr}(p), and for interpolated depths Sᵢ(p) at step 441. Confidence scores for depth sensor measurements can be assigned the highest values (such as 1.0) reflecting high reliability. Confidence scores for reconstructed and interpolated depths can be computed, for example, based on factors such as texture strength, matching confidence, and distance from measured depth values.

As part of the process of creating a confidence map with confidence scores at step 440, the electronic device can create a confidence map S(p) with the confidence scores from different sources at step 442. For example, confidence map can be represented as

$$S ( p ) = \{ \begin{matrix}{S}_{fs} ( p ) , if there is depth sensor depth exists , \\ {S}_{fr} ( p ) , if there is only reconstructed depth exists , \\ {S}_{i} ( p ) , if there is only interpolated depth exists .\end{matrix}$$

The confidence map S(p) corresponds to the initial dense depth map d(p).

As part of the process of creating a confidence map with confidence scores at step 440, the electronic device can make correspondences among color, depth, and confidence score of the pixel with the captured image I(p), mapped depth d(p), and confidence score S(p) at step 443. Establishing these correspondences can create a data structure that associates each pixel location with its color value from the see-through image, its estimated depth value, and its confidence score. This correspondence can enable the depth edge preserving filter to leverage color information when refining depth estimates.

As part of the process of obtaining the initial estimation of the depth map at step 450, the electronic device can obtain the initial estimation of the depth map for refinement at step 451. The initial depth map estimation can combine the fused depths from multiple sources with interpolated values for depth-empty pixels, providing depth values at all pixel locations. This initial estimation can serve as the input for the depth edge preserving filter created in process 600 of FIG. 6.

As part of the process of obtaining the initial estimation of the depth map at step 450, the electronic device can obtain the confidence map corresponding to the initial depth map for depth refinement at step 452. The confidence map can provide per-pixel confidence scores that guide the depth edge preserving filter to focus refinement efforts on low-confidence regions while preserving high-confidence depth measurements. The correspondence between the initial depth map and confidence map can enable targeted depth refinement as described, for example, in process 900 of FIG. 9.

Although FIG. 4 illustrates one example of a process 400 for initial estimation of depth maps with depth fusion and depth interpolation in accordance with this disclosure, various changes may be made to FIG. 4. For example, various operations or functions in FIG. 4 may be combined, further subdivided, replicated, omitted, or rearranged and additional operations or functions may be added according to particular needs. Also, different portions of the process 400 could be performed using different devices, such as when one or more operations are performed by a first electronic device (like an HMD) and one or more other operations is performed offline by a second electronic device, for example to determine or configure appropriate parameters, or before the first electronic device is deployed.

The process illustrated in FIG. 4 provides significant technical advantages when implemented in a head-mounted display. By fusing depths from multiple depth sources, such as depth sensors and stereo image pairs captured by the HMD's onboard cameras, and interpolating depths with associated confidence scores, the disclosed approach enables accurate initial estimation of dense depth maps using the limited computational resources available within the HMD. This efficient depth fusion and interpolation process allows the HMD to handle varying scene complexities while maintaining real-time performance, ensuring that subsequent depth densification and passthrough transformation operations have a reliable foundation for producing high-quality final view images.

FIG. 6 illustrates a process 600 for creating depth edge preserving filtering for depth computing in accordance with this disclosure. For ease of explanation, the process 600 of FIG. 6 is described as being implemented using the electronic device 101 in the network configuration 100 of FIG. 1. However, the process 600 may be implemented using any other suitable device(s) (such as the server 106) and in any other suitable system(s). The high-level processes described in the context of FIG. 6 can include any number of other processes and subprocesses, including those described with respect to other figures herein.

FIG. 6 includes a number of high-level actions that can be performed the electronic device, each of which can include one or more sub-steps. In this example, process 400 includes high-level actions of creating relationship between depth and image color at step 610, computing parameters of the depth edge preserving filter at step 620, parameter optimization of the depth edge preserving filter at step 630, integrating parameters to the depth edge preserving filter at step 640, and obtaining the depth edge preserving filter at step 650. Some aspects of the process 600 may be illustrated with respect to FIG. 7, below.

As part of the process of creating relationship between depth and image color at step 610, the electronic device can create an affine transform between depths and corresponding image colors at step 611. The affine transform can model the relationship between depth values and pixel colors within a local patch as a linear function, such as illustrated in FIG. 7. This affine model assumes that depth values can be approximated as a linear combination of the color values plus a constant offset within small image regions.

As part of the process of creating relationship between depth and image color at step 610, the electronic device can define the corresponding image as guidance at step 612. The guidance image can be the high-resolution color image captured by the see-through cameras, which provides structural information about object boundaries and surface regions. Edge and texture features in the guidance image inform the depth edge preserving filter about where depth discontinuities are likely to occur.

As part of the process of creating relationship between depth and image color at step 610, the electronic device can define a moving window for affine transform at step 613. The moving window can define a local patch size over which the affine transform parameters are computed. The window size balances the need for sufficient data to estimate parameters reliably against the assumption that the affine relationship holds within the window region.

FIG. 7 illustrates an example 700 of creating a depth edge preserving filter with parameters, to illustrate an implementation of process 600. In a small patch wₖ, the electronic device can create an affine transform 720 between the depth dᵢ(p) illustrated at 730 and the corresponding pixel color Iᵢ(p) illustrated at 710:

dᵢ(p)=αₖIᵢ(p)+βₖ,i∈wₖ

where, (αₖ,βₖ) are the affine transform parameters 740 which can be computed from the guided image Iᵢ and initial estimation of the depth map Dᵢ.

As part of the process of computing parameters of the depth edge preserving filter at step 620, the electronic device can define the depth edge preserving filter with the parameters (αₖ,βₖ) at step 621. The filter can be defined by parameters that relate depth values to color values according to the affine model established at step 610. These parameters can enable the filter to produce depth estimates that follow the structural patterns present in the guidance color image.

As part of the process of computing parameters of the depth edge preserving filter at step 620, the electronic device can compute the parameters of the edge preserving filter with a moving window at step 622, using

$$\{ \begin{matrix}{α}_{k} = h ( {I}_{i} , {D}_{i} ) \\ {β}_{k} = j ( {I}_{i} , {D}_{i} )\end{matrix} , i ∈ {w}_{k}$$

where, wₖ is the window of the small patch, Iᵢ is the guidance image, and Dᵢ is the initial estimation of the depth map.

As part of the process of computing parameters of the depth edge preserving filter at step 620, the electronic device can compute the parameters of the edge preserving filter with overlapping windows at step 623. Using overlapping windows can provide multiple parameter estimates for pixels that fall within multiple windows, enabling more robust parameter computation. The overlap ensures smooth transitions in the filtered depth values across window boundaries.

As part of the process of parameter optimization of the depth edge preserving filter at step 630, the electronic device can compute the parameters of the depth edge preserving filter by considering confidence scores at step 631. Incorporating confidence scores into parameter computation can weight the contributions of high-confidence depth measurements more heavily than low-confidence estimates. This weighting can ensure that the filter parameters are primarily determined by reliable depth data while still considering all available information.

As part of the process of parameter optimization of the depth edge preserving filter at step 630, the electronic device can optimize the parameters of the depth edge preserving filter at step 632. Parameter optimization can include minimizing an objective function that balances fidelity to measured depths with smoothness constraints guided by the color image structure. The optimization can employ iterative techniques or closed-form solutions depending on the specific filter formulation.

As part of the process of parameter optimization of the depth edge preserving filter at step 630, the electronic device can integrate the computed parameters and confidence scores for the depth edge preserving filter at step 633. Integration of parameters and confidence scores can create a complete filter specification that can produce depth-aware refinement. The integrated filter can be configured to apply stronger smoothing in regions with low-confidence depth estimates while preserving depth values in high-confidence regions.

As part of the process of integrating parameters to the depth edge preserving filter at step 640, the electronic device can obtain optimized parameters from the optimization process at step 641. The optimized parameters can represent the best-fit affine coefficients for each local window region, computed to minimize depth estimation error while respecting color-guided edge constraints. These parameters can encode the local relationship between depth and color that will guide subsequent depth refinement.

As part of the process of integrating parameters to the depth edge preserving filter at step 640, the electronic device can integrate the computed parameters to the depth edge preserving filter at step 642. Integrating the parameters can configure the filter to apply the learned depth-color relationships when processing the initial depth map. The integrated filter can then be used to refine depth estimates by propagating depth information from high-confidence regions to low-confidence regions along color-consistent paths.

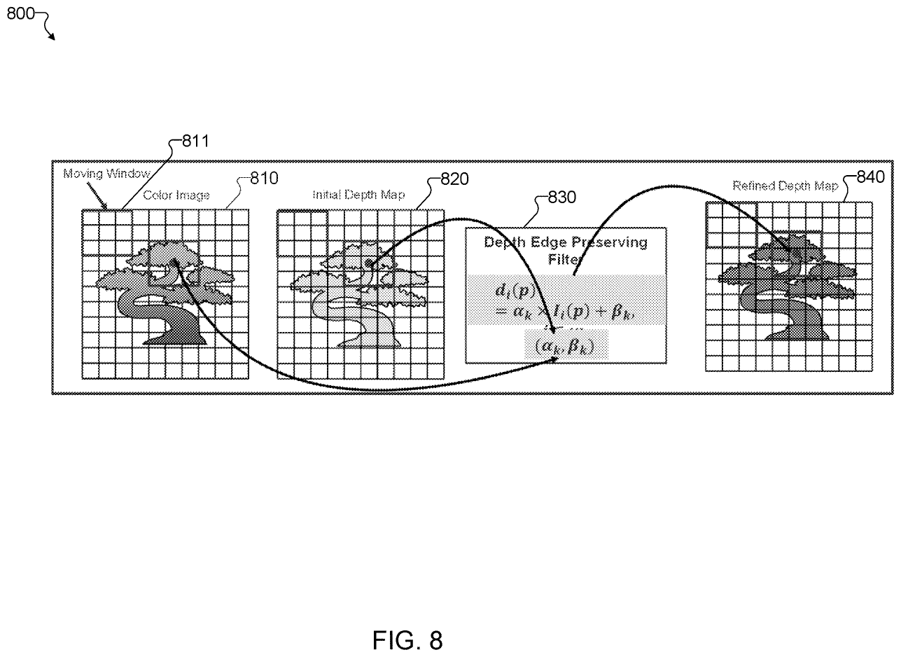

As part of the process of integrating parameters to the depth edge preserving filter at step 640, the electronic device can apply the depth edge preserving filter to overlapping windows at step 643. Applying the filter with overlapping windows produces multiple depth estimates for each pixel from different window contexts, such as illustrated in FIG. 8. The final depth estimate at each pixel can be computed as an average or weighted average of these multiple estimates.

As part of the process of obtaining the depth edge preserving filter at step 650, the electronic device can obtain the depth edge preserving filter with parameters at step 651. The depth edge preserving filter with integrated parameters can represent a complete filtering system capable of refining depth maps while preserving edge structures. The filter can encapsulate the computed depth-color relationships and be configured for efficient application across the full image resolution.

As part of the process of obtaining the depth edge preserving filter at step 650, the electronic device can make the depth edge preserving filter ready for depth computing with moving windows at step 652. Making the filter ready can include preparing data structures and computational resources for efficient application of the filter across the image using the moving window approach. The prepared filter can then be applied, for example, in process 900 of FIG. 9 for depth densification and depth hole filling.

Although FIG. 6 illustrates one example of a process 600 for creating depth edge preserving filtering for depth computing in accordance with this disclosure, various changes may be made to FIG. 6. For example, various operations or functions in FIG. 6 may be combined, further subdivided, replicated, omitted, or rearranged and additional operations or functions may be added according to particular needs. Also, different portions of the process 600 could be performed using different devices, such as when one or more operations are performed by a first electronic device (like an HMD) and one or more other operations is performed offline by a second electronic device, for example to determine or configure appropriate parameters, or before the first electronic device is deployed.

The process illustrated in FIG. 6 provides significant technical advantages when implemented in a head-mounted display. By creating a depth edge preserving filter with optimized parameters computed from the HMD's captured color images, the disclosed approach enables precise depth refinement that maintains sharp boundaries at object edges, which can be an important consideration for accurate occlusion handling in mixed reality applications. The use of guidance from corresponding color images allows the filter to leverage the high-resolution visual information already available within the HMD, minimizing additional sensor requirements while producing depth maps that properly preserve scene structure. This results in more realistic integration of virtual content with real-world scenes as displayed to the HMD user.

FIG. 8 illustrates a non-limiting example 800 of integration of the depth edge preserving filter that may be used, for example, in process 600 of FIG. 6. In this example, the color image 810 in the original input data is processed using a moving window 811. The electronic device can produce the refined depth map 840 by computing and integrate parameters (αₖ,βₖ) to the depth edge preserving filter 830 with the color image 810 and initial depth map 820 using the moving window 811.

FIG. 9 illustrates a process 900 for depth densification and depth hole filtering with edge preserving filtering in accordance with this disclosure. For ease of explanation, the process 900 of FIG. 9 is described as being implemented using the electronic device 101 in the network configuration 100 of FIG. 1. However, the process 900 may be implemented using any other suitable device(s) (such as the server 106) and in any other suitable system(s). The high-level processes described in the context of FIG. 9 can include any number of other processes and subprocesses, including those described with respect to other figures herein.

FIG. 9 includes a number of high-level actions that can be performed the electronic device, each of which can include one or more sub-steps. In this example, process 400 includes high-level actions of obtaining the created depth edge preserving filter at step 910, finalizing depths with the depth edge preserving filter at step 920, reducing depth noises with the depth edge preserving filter at step 930, post processing for the finalized depth map at step 940, and obtaining the finalized dense depth map at step 950. Some aspects of the process 900 may be illustrated with respect to FIGS. 10 and 11, below.

As part of the process of obtaining the depth edge preserving filter at step 910, the electronic device can obtain the depth edge preserving filter with computed parameters at step 911, such as those created in process 600.

As part of the process of obtaining the depth edge preserving filter at step 910, the electronic device can obtain the color image corresponding to the initial depth map estimation at step 912, such as that created in process 400.

As part of the process of obtaining the depth edge preserving filter at step 910, the electronic device can create a schedule for moving windows for depth filtering and refining at step 913. The schedule can define the order and pattern in which the moving windows traverse the image during filter application. The scheduling approach can include, for example, raster scan ordering, multi-scale processing from coarse to fine resolution, or priority-based ordering that processes low-confidence regions first.

As part of the process of finalizing depths with the depth edge preserving filter at step 920, the electronic device can obtain the initial estimation of the depth map and the corresponding color image at step 921. The initial depth map estimation can be obtained, for example, from process 400 of FIG. 4 and can include fused and interpolated depths with varying confidence levels. The corresponding color image can provide the guidance information that directs depth refinement along color-consistent boundaries.

As part of the process of finalizing depths with the depth edge preserving filter at step 920, the electronic device can compute depths for pixels with low confidence scores with depth edge preserving filtering at step 922. Computing depths for low-confidence pixels can include applying the filter parameters within each moving window to estimate refined depth values based on neighboring high-confidence depths and guided by the color image structure. The non-limiting example illustrated in FIG. 10 shows how the filter can refine depths at pixels with low confidence scores.

FIG. 10 illustrates a non-limiting example of finalizing depths with the depth edge preserving filter as process 1000.

Suppose pixel pᵢ with depth dᵢ in the initial depth map 1010 has a low confidence score Sᵢ. The electronic device can finalize the depth dᵢ of pixel pᵢ with the depth edge preserving filter 1030 with guidance of the color image 1020, producing finalized depth map 1040.

Similar to the illustration of FIG. 8, the electronic device define a moving window centered at pixel pk with a define window size. The electronic device can move the window to compute the linear coefficients (αₖ,βₖ) and the depth dᵢ of pixel pᵢ. The electronic device can replace the original depth with the refined depth for pixel pᵢ. Moving the window in the initial depth map, the electronic device may have multiple windows which cover pixel pᵢ.

FIG. 11A illustrates a non-limiting example of depth filtering 1100. In this example, pixel pᵢ is covered by several windows w₁, w₂, w₃, w₄, wₖ as shown at 1120. In each window wₖ, the electronic device can compute the linear transform coefficients (αₖ,βₖ) and compute depth dᵢ in this window, for example using

dᵢⱼ(p)=αₖⱼlᵢ+βₖⱼ

where (αₖⱼ,βₖⱼ) are the linear transform coefficients in window wₖⱼ centered at pixel pₖⱼ, j is the index of windows which cover pixel pᵢ. In the example shown in FIG. 11A, j=1, 2, 3, 4, k at 1120.

To more clearly illustrate the overlapping windows, FIG. 11B illustrates only the pixel pᵢ and the windows w₁, w₂, w₃, w₄, wₖ as shown at 1120, without the “scene” icon or the grid lines. Different windows are represented by different line formats.

In this case, the electronic device can compute the final finalized depth dᵢ(p) with the average or weighted average of the multiple depth dᵢⱼ computed with multiple windows wₖⱼ, as

$${d}_{i} ( p ) = \frac{1}{{N}_{j}} {\sum }_{j} {d}_{ij} ( p )$$

where, Nⱼ is the number of windows which cover pixel pᵢ and dᵢⱼ is the depth computed in window wₖⱼ.

Returning to the process of FIG. 9, the electronic device can integrate the new computed depth to the depth map at step 923 by replacing the depth dᵢ(p) in the initial depth map 1110 with the refined depth dᵢ(p) to obtain the refined depth map 1140.

As part of the process of reducing depth noises with the depth edge preserving filter at step 930, the electronic device can obtain pixels with low signal to noise ratio (SNR) scores in depths at step 931. Low SNR pixels can be identified, for example, based on statistical analysis of depth measurements, detection of outliers relative to neighboring depths, or analysis of temporal consistency across multiple frames. These low SNR pixels can be candidates for noise reduction using the depth edge preserving filter.

As part of the process of reducing depth noises with the depth edge preserving filter at step 930, the electronic device can compute depths for the pixels with low SNR scores with the depth edge preserving filtering at step 932. Computing refined depths for noisy pixels can include applying the edge preserving filter to replace noisy depth values with estimates that are consistent with neighboring depths while respecting color-indicated boundaries. The filtering approach can reduce high-frequency noise while preserving genuine depth discontinuities at object edges.

As part of the process of reducing depth noises with the depth edge preserving filter at step 930, the electronic device can integrate the new computed depths to the depth map at step 933. Integrating the noise-reduced depths can include replacing the original noisy depth values with the refined estimates in the depth map data structure. The updated depth map retains high-quality depth measurements while improving the accuracy of previously noisy regions.

As part of the process of post processing for the finalized depth map at step 940, the electronic device can verify the new computed depths for the pixels with low confidence scores at step 941. Verification can include comparing the refined depths against neighboring depths to detect outliers, checking consistency with the original depth sensor measurements where available, and validating that depth values fall within expected ranges for the scene. Pixels that fail verification can be flagged for additional processing.

As part of the process of post processing for the finalized depth map at step 940, the electronic device can verify the new depths for the pixels with low SNR scores at step 942. Verifying noise-reduced depths can include analyzing the spatial smoothness of the refined depth values and checking that depth transitions align with edges detected in the color image. Verification ensures that the noise reduction process has not introduced artifacts or blurred genuine depth discontinuities.

As part of the process of post processing for the finalized depth map at step 940, the electronic device can modify the depths according to depth verification results with the depth edge preserving filtering at step 943. Modifying depths based on verification can include reprocessing pixels that failed verification using adjusted filter parameters, interpolating from verified neighboring depths, or applying additional filtering passes with different window sizes. The modifications ensure that the final depth map meets quality requirements.

As part of the process of obtaining the finalized dense depth map at step 950, the electronic device can obtain the finalized dense depth map with hole filled at step 951. The finalized dense depth map can contain refined depth values at all pixel locations, including regions that originally lacked depth measurements from sensors or reconstruction. The depth holes have been filled using the depth edge preserving filter guided by the color image structure to ensure plausible depth values.

As part of the process of obtaining the finalized dense depth map at step 950, the electronic device can make the dense depth map ready for passthrough transformation at step 952. Making the depth map ready includes formatting the depth data for efficient access during passthrough transformation operations, such as depth-based reprojection and viewpoint matching. The prepared dense depth map enables the generation of high-quality final view frames as described at step 350 of FIG. 3.

Although FIG. 9 illustrates one example of a process 900 for depth densification and depth hole filtering with edge preserving filtering in accordance with this disclosure, various changes may be made to FIG. 9. For example, various operations or functions in FIG. 9 may be combined, further subdivided, replicated, omitted, or rearranged and additional operations or functions may be added according to particular needs. Also, different portions of the process 900 could be performed using different devices, such as when one or more operations are performed by a first electronic device (like an HMD) and one or more other operations is performed offline by a second electronic device, for example to determine or configure appropriate parameters, or before the first electronic device is deployed.

The process illustrated in FIG. 9 provides significant technical advantages when implemented in a head-mounted display. By using the depth edge preserving filter to finalize depths at pixels with low confidence scores and reduce depth noise, the disclosed approach produces clean, complete dense depth maps suitable for high-quality passthrough rendering within the HMD. The post-processing operations verify and correct computed depths, ensuring that the final depth map accurately represents scene geometry. This accurate depth representation enables the HMD to perform precise viewpoint matching and parallax correction, reducing visual artifacts such as depth discontinuities and improper object placement that can cause user discomfort in video see-through mixed reality applications.

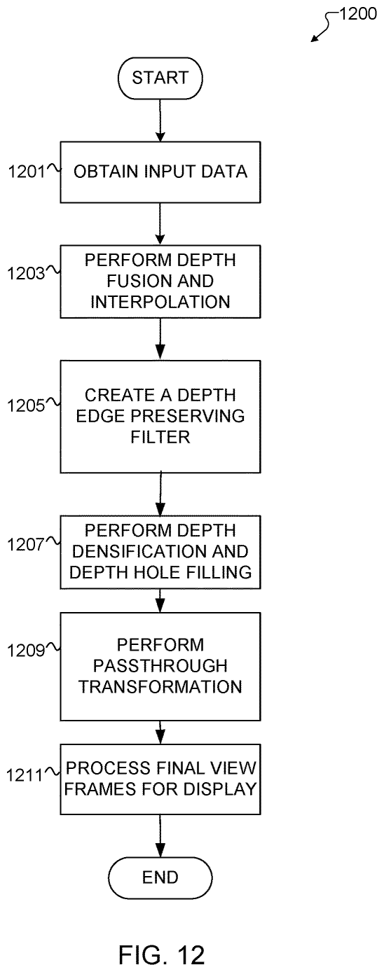

FIG. 12 illustrates an integrated process for depth densification and hole filling with depth edge preserving filtering for video see-through mixed reality or other applications in accordance with the disclosure. For ease of explanation, the process 1200 of FIG. 12 is described as being implemented using the electronic device 101 in the network configuration 100 of FIG. 1. However, the process 1200 may be implemented using any other suitable device(s) (such as the server 106) and in any other suitable system(s). The high-level processes described in the context of FIG. 12 can include any number of other processes and subprocesses, including those described with respect to other figures herein.

The electronic device can obtain input data at step 1201, for example using at least one processing device. The input data can include an image frame sequence of see-through color image frames captured using one or more image sensors and depth data captured using a depth sensor. In some cases, the depth data can include depth information reconstructed from stereo image pairs of the image frame sequence. In some cases, the image frame sequence can include stereo image pairs of color image frames captured using multiple image sensors and the depth data can include depth information reconstructed from the stereo image pairs. In some cases, the depth data can include structure from motion information computed from the image frame sequence. This step can generally correspond, for example, to the data collection actions described at step 310 of FIG. 3, which includes capturing see-through color frames, depth data, stereo image pairs, and head pose data.

The electronic device can perform depth fusion and interpolation on a frame of the image frame sequence using the depth data at step 1203. This step can generally correspond, for example, to the process 400 described in FIG. 4, which details the initial estimation of depth maps through depth fusion from multiple depth sources, depth interpolation for depth-empty pixels, and creation of confidence maps.

The electronic device can create a depth edge preserving filter, based on structures and features of the image frame at step 1205. This can include computing parameters of the depth edge preserving filter. This step can generally correspond, for example, to the process 600 described in FIG. 6, which details creating the relationship between depth and image color, computing and optimizing parameters of the depth edge preserving filter, and integrating those parameters into the filter.

In some cases, creating a depth edge preserving filter can include one or more processes such as creating a relationship between the depth data and the structures and features of the image frame, where the parameters of the depth edge preserving filter are based on the relationship, and integrating the parameters with the depth edge preserving filter. These processes can generally correspond, for example, to steps 610 through 640 of process 600 in FIG. 6, and may utilize the affine transform approach illustrated in FIG. 7 and the filter integration approach illustrated in FIG. 8.

The electronic device can perform depth densification and depth hole filling at step 1207, for example using the depth edge preserving filter and the parameters, to create a dense depth map of the image frame. This step can generally correspond, for example, to the process 900 described in FIG. 9, which details finalizing depths with the depth edge preserving filter, reducing depth noises, and performing post processing to obtain the finalized dense depth map.

In some cases, performing depth densification and depth hole filling can include one or more processes such as fusing depth information reconstructed from the stereo image pairs with the depth data captured using the depth sensor, interpolating depths for depth-empty pixels of the image frame based on depth densification and depth hole filling, creating a confidence map with confidence scores for individual pixels of the image frame, and creating an initial estimation of the dense depth map based on the confidence map, the depth data, and the interpolated depths. These processes can generally correspond, for example, to steps 410 through 450 of process 400 in FIG. 4, and may utilize the depth fusion approach illustrated in FIG. 5.

In some cases, performing depth densification and depth hole filling can include one or more processes such as fusing finalizing depths at individual pixels of the image frame having low confidence scores of estimated depths, using the depth edge preserving filter, and removing noise at the individual pixels of the image frame having low confidence scores of estimated depths using the depth edge preserving filter. These processes can generally correspond, for example, to steps 920 and 930 of process 900 in FIG. 9, and may utilize the depth finalization approach illustrated in FIG. 10 and the depth filtering approach illustrated in FIG. 11.

In some cases, performing depth densification and depth hole filling can include performing post processing for the dense depth map based on the finalized depths. This post processing can generally correspond, for example, to step 940 of process 900 in FIG. 9, which includes verifying new computed depths and modifying depths according to verification results.

The electronic device can perform passthrough transformation at step 1209, such as according to the dense depth map and the image frame sequence to produce final view frames. This step can generally correspond, for example, to the passthrough transformation actions described at step 350 of FIG. 3, which includes static passthrough transformation, dynamic passthrough transformation, and generation of the final view frames.

The electronic device can process the final view frames for display on at least one display device at step 1211. This step can generally correspond, for example, to the final frame rendering and displaying actions described at step 360 of FIG. 3, which includes display geometric distortion and chromatic aberration correction, blending of see-through images with virtual objects, and rendering the enhanced frames to display panels.

Although FIG. 12 illustrates one example of an integrated process 1200 for depth densification and hole filling with depth edge preserving filtering for video see-through mixed reality or other applications in accordance with this disclosure, various changes may be made to FIG. 12. For example, various operations or functions in FIG. 12 may be combined, further subdivided, replicated, omitted, or rearranged and additional operations or functions may be added according to particular needs. Also, different portions of the process 1200 could be performed using different devices, such as when one or more operations are performed by a first electronic device (like an HMD) and one or more other operations is performed offline by a second electronic device, for example to determine or configure appropriate parameters, or before the first electronic device is deployed.

The process illustrated in FIG. 12 provides significant technical advantages when implemented in a head-mounted display. As an integrated pipeline combining depth fusion, edge preserving filter creation, depth densification, and passthrough transformation, the disclosed process enables efficient end-to-end processing within the computational and power constraints of a wearable HMD device. By structuring these operations as a cohesive workflow, the HMD can generate high-quality final view frames with minimal latency, which is essential for maintaining temporal consistency and user comfort during head movements. The integrated approach also facilitates optimization across processing stages, enabling the HMD to deliver enhanced visual quality for video see-through mixed reality experiences while efficiently managing onboard resources.

Various embodiments can create depth maps from any depth sources such as depths captured from depth sensors, depths reconstructed from stereo image pairs, depths from structure from motion (SFM), or depths from other sources. Disclosed processes can be used with any system that receives depths from any depth sources. After obtaining sparse depths or point clouds, the disclosed embodiments can create a dense depth map with densification and depth hole filling.

In some cases, disclosed processes can incorporate machine learning (ML) techniques. For example, a ML model can be used fuse and interpolate the depths to create an initial depth map. The electronic device can create training datasets and train the ML model to let the ML model to learn the relationship between sparse depths and the dense depth map. The electronic device can create an initial depth map with the trained ML model. After obtaining the initial depth map, the electronic device can refine the initial depth map with the created edge preserving filter to obtain the refined dense depth map.

Disclosed embodiments provide significant technical advantages in creating dense depth maps from sparse depths generated by depth sensors or depth reconstruction from stereo image pairs. By enabling the generation of dense depth maps from limited depth data, the disclosed techniques improve the accuracy and completeness of depth-based reprojection and 3D scene reconstruction, resulting in enhanced visual quality and reduced artifacts in video see-through mixed reality applications.

Disclosed embodiments provide significant technical advantages in addressing depth holes that arise in depth maps created by depth sensors or 3D reconstruction. Conventional approaches often leave areas without available depth information, resulting in depth holes that degrade the quality of downstream processing. The disclosed techniques advantageously generate new depths to fill these depth holes, thereby producing more complete and accurate depth maps. This improvement enhances the overall performance of the video see-through pipeline by reducing visual discontinuities and improving the fidelity of rendered content.

Disclosed embodiments provide significant technical advantages in creating dense depth maps for 3D scene reconstruction and 3D object reconstruction. By combining depth densification with super resolution techniques, the disclosed approaches generate high-resolution dense depth maps from sparse depths and low-resolution depth data. This capability provides improved spatial resolution and detail in 3D scene reconstruction, enabling more accurate and realistic representations of physical environments compared to conventional methods that rely solely on raw sensor data.

In one embodiment, a head mounted device (HMD) includes a housing structure shaped to be worn on a user's head. The device includes a pair of external see-through cameras coupled to the structure so as to face toward a front side of the structure. A plurality of tracking cameras are coupled to the structure so as to face toward the front side of the structure for providing stereo image pairs. A display is configured to display an image and/or video to the user wearing the structure. At least one motion sensor, such as an inertial measurement unit (IMU), is positioned inside the structure. At least one depth sensor, such as a time-of-flight sensor or Lidar, is coupled to the structure so as to face toward the front side of the structure. At least one eye-tracking sensor is positioned to track the user's eyes.

A processor is operatively connected to the cameras, the display, the motion sensor, the depth sensor, and the eye-tracking sensor. A memory is operatively connected to the processor, and the memory stores instructions that, when executed, cause the processor to perform certain operations while running a video see-through pipeline.

In operation, the processor receives data from one or more of the external cameras, the motion sensor, the tracking cameras, and the depth sensor. This data can include an image frame sequence of see-through color image frames captured using the external cameras, depth data from the depth sensor, depth reconstructed from stereo image pairs captured using the tracking cameras, and head pose data from the motion sensor.

The processor can perform depth fusion and interpolation using depths from the depth sensor, depths from structure from motion (SFM), and/or depths from the stereo image pairs. The processor can then create a depth edge preserving filter for computing new depths with guidance of corresponding color images and computing parameters of the filter using image structure and feature information from the color image frames.

The processor can perform depth densification and depth hole filling by generating new depths with the created depth edge preserving filter to create dense depth maps for depth-based processing. After completing the depth densification and depth hole filling, the processor can perform passthrough transformation, which may be static and/or dynamic. Following the passthrough transformation, the processor can render the final view frames to the display.

In some implementations, during the depth fusion and interpolation operation, the processor may fuse depths from different depth sensors, fuse depths reconstructed from stereo image pairs, interpolate depths to depth empty pixels for depth densification and depth hole filling, create a confidence map with confidence scores for individual pixels, and obtain an initial estimation of the depth map.

In some implementations, during the creation of the depth edge preserving filter, the processor may create a relationship between depths and color image with guidance of the color image frames, compute parameters of the depth edge preserving filter, optimize and finalize the parameters of the depth filter, and integrate the computed parameters with the depth edge preserving filter.

In some implementations, during the depth densification and depth hole filling operation, the processor may obtain the depth edge preserving filter with the optimized parameters, finalize depths at individual pixels with low confidence scores of estimated depths using the depth edge preserving filter, and remove noises at the individual pixels with the low confidence scores of estimated depths using the depth edge preserving filter.

In some implementations, during the depth densification and depth hole filling operation, the processor may also perform post processing for the finalized depth map and obtain the finalized dense depth map with the depth edge preserving filter.

It should be noted that the functions shown in the figures or described above can be implemented in an electronic device 101, 102, 104, server 106, or other device(s) in any suitable manner. For example, in some embodiments, at least some of the functions shown in the figures or described above can be implemented or supported using one or more software applications or other software instructions that are executed by the processor 120 of the electronic device 101, 102, 104, server 106, or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions. Also, the functions shown in the figures or described above can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
obtaining, using at least one processing device of an electronic device, input data, wherein the input data includes an image frame sequence of see-through color image frames captured using one or more image sensors and depth data captured using a depth sensor;
performing depth fusion and interpolation on a frame of the image frame sequence using the at least one processing device and the depth data;
creating a depth edge preserving filter, using the at least one processing device, based on structures and features of the image frame, including computing parameters of the depth edge preserving filter;
performing depth densification and depth hole filling, using the at least one processing device, the depth edge preserving filter, and the parameters, to create a dense depth map of the image frame;
performing passthrough transformation, using the at least one processing device, according to the dense depth map and the image frame sequence to produce final view frames; and
processing, using the at least one processing device, the final view frames for display on at least one display device.

2. The method of claim 1, wherein the depth data includes depth information reconstructed from stereo image pairs of the image frame sequence, and performing depth densification and depth hole filling comprises:
fusing depth information reconstructed from the stereo image pairs with the depth data captured using the depth sensor;
interpolating depths for depth-empty pixels of the image frame based on depth densification and depth hole filling;
creating a confidence map with confidence scores for individual pixels of the image frame; and
creating an initial estimation of the dense depth map based on the confidence map, the depth data, and the interpolated depths.

3. The method of claim 1, wherein creating a depth edge preserving filter comprises:
creating a relationship between the depth data and the structures and features of the image frame, wherein the parameters of the depth edge preserving filter are based on the relationship; and
integrating the parameters with the depth edge preserving filter.

4. The method of claim 1, wherein performing depth densification and depth hole filling comprises:
finalizing depths at individual pixels of the image frame having low confidence scores of estimated depths, using the depth edge preserving filter; and
removing noise at the individual pixels of the image frame having low confidence scores of estimated depths using the depth edge preserving filter.

5. The method of claim 4, wherein performing depth densification and depth hole filling includes performing post processing for the dense depth map based on the finalized depths.

6. The method of claim 1, wherein the image frame sequence includes stereo image pairs of color image frames captured using multiple image sensors and the depth data includes depth information reconstructed from the stereo image pairs.

7. The method of claim 1, wherein the depth data includes structure from motion information computed from the image frame sequence.

8. An electronic device comprising:
at least one processing device configured to:
obtain input data, wherein the input data includes an image frame sequence of see-through color image frames captured using one or more image sensors and depth data captured using a depth sensor;
perform depth fusion and interpolation on a frame of the image frame sequence using the depth data;
create a depth edge preserving filter based on structures and features of the image frame, including computing parameters of the depth edge preserving filter;
perform depth densification and depth hole filling, using the depth edge preserving filter and the parameters, to create a dense depth map of the image frame;
perform passthrough transformation according to the dense depth map and the image frame sequence to produce final view frames; and
process the final view frames for display on at least one display device.

9. The electronic device of claim 8, wherein the depth data includes depth information reconstructed from stereo image pairs of the image frame sequence, and to perform the depth densification and depth hole filling, the at least one processing device is configured to:
fuse depth information reconstructed from the stereo image pairs with the depth data captured using the depth sensor;
interpolate depths for depth-empty pixels of the image frame based on depth densification and depth hole filling;
create a confidence map with confidence scores for individual pixels of the image frame; and
create an initial estimation of the dense depth map based on the confidence map, the depth data, and the interpolated depths.

10. The electronic device of claim 9, wherein to create the depth edge preserving filter, the at least one processing device is configured to:
create a relationship between the depth data and the structures and features of the image frame, wherein the parameters of the depth edge preserving filter are based on the relationship; and
integrate the parameters with the depth edge preserving filter.

11. The electronic device of claim 8, wherein to perform depth densification and depth hole filling, the at least one processing device is configured to:
finalize depths at individual pixels of the image frame having low confidence scores of estimated depths, using the depth edge preserving filter; and
remove noise at the individual pixels of the image frame having low confidence scores of estimated depths using the depth edge preserving filter.

12. The electronic device of claim 11, wherein, to perform depth densification and depth hole filling, the at least one processing device is configured to perform post processing for the dense depth map based on the finalized depths.

13. The electronic device of claim 8, wherein the image frame sequence includes stereo image pairs of color image frames captured using multiple image sensors and the depth data includes depth information reconstructed from the stereo image pairs.

14. The electronic device of claim 8, wherein the depth data includes structure from motion information computed from the image frame sequence.

15. A non-transitory machine readable medium containing instructions that when executed cause at least one processor of an electronic device to:
obtain input data, wherein the input data includes an image frame sequence of see-through color image frames captured using one or more image sensors and depth data captured using a depth sensor;
perform depth fusion and interpolation on a frame of the image frame sequence using the depth data;
create a depth edge preserving filter based on structures and features of the image frame, including computing parameters of the depth edge preserving filter;
perform depth densification and depth hole filling, using the depth edge preserving filter and the parameters, to create a dense depth map of the image frame;
perform passthrough transformation according to the dense depth map and the image frame sequence to produce final view frames; and
process the final view frames for display on at least one display device.

16. The non-transitory machine readable medium of claim 15, wherein the depth data includes depth information reconstructed from stereo image pairs of the image frame sequence, and the instructions that when executed cause the at least one processor to perform the depth densification and depth hole filling comprise instructions that when executed cause the at least one processor to:
fuse depth information reconstructed from the stereo image pairs with the depth data captured using the depth sensor;
interpolate depths for depth-empty pixels of the image frame based on depth densification and depth hole filling;
create a confidence map with confidence scores for individual pixels of the image frame; and
create an initial estimation of the dense depth map based on the confidence map, the depth data, and the interpolated depths.

17. The non-transitory machine readable medium of claim 15, wherein the instructions that when executed cause the at least one processor to create the depth edge preserving filter comprise instructions that when executed cause the at least one processor to:
create a relationship between the depth data and the structures and features of the image frame, wherein the parameters of the depth edge preserving filter are based on the relationship; and
integrate the parameters with the depth edge preserving filter.

18. The non-transitory machine readable medium of claim 15, wherein the instructions that when executed cause the at least one processor to perform depth densification and depth hole filling comprise instructions that when executed cause the at least one processor to:
finalize depths at individual pixels of the image frame having low confidence scores of estimated depths, using the depth edge preserving filter; and
remove noise at the individual pixels of the image frame having low confidence scores of estimated depths using the depth edge preserving filter.

19. The non-transitory machine readable medium of claim 18, wherein the instructions that when executed cause the at least one processor to perform depth densification and depth hole filling comprise instructions that when executed cause the at least one processor to perform post processing for the dense depth map based on the finalized depths.

20. The non-transitory machine readable medium of claim 15, wherein the image frame sequence includes stereo image pairs of color image frames captured using multiple image sensors, and the depth data includes depth information reconstructed from the stereo image pairs and includes structure from motion information computed from the image frame sequence.
